(19) United States
(12) Patent Application Publication
(10) Pub. No.: US 2026/0269737 A1
(43) Pub. Date: Sep. 10, 2026

(54) POWER CONVERTER, CONTROLLER, AND CONTROL METHOD

(71) Applicant: FUJI ELECTRIC CO., LTD., Kanagawa (JP)

(72) Inventor: Osamu HIKONE, Mie (JP)

(21) Appl. No.: 19/459,473

(22) Filed: Jan. 26, 2026

(30) Foreign Application Priority Data
Mar. 7, 2025 (JP) 2025-036429

(51) Int. Cl. H02M 5/458

(52) U.S. Cl. CPC H02M 5/4585

(57) ABSTRACT

A power converter selectively uses a cell balance mode and a cell imbalance mode, the cell balance mode is a mode in which each of a plurality of single-phase AC output units superimposes only outputs of a number of power conversion cells corresponding to a minimum number of the numbers of available power conversion cells to output single phase AC, and the cell imbalance mode is a mode in which each of the plurality of single-phase AC output units superimposes outputs of all available power conversion cells to output the single-phase AC such that phase differences between line-to-line voltages of adjacent phases among phases are all equivalent.

### CROSS-REFERENCE TO RELATED APPLICATIONS

The present application is based on and claims priority to Japanese patent application No. 2025-036429 filed on Mar. 7, 2025, with the Japanese Patent Office, the entire contents of which are hereby incorporated by reference.

### BACKGROUND OF THE INVENTION

The present disclosure relates to a power converter and the like.

For example, a multilevel power converter in which output units of a predetermined number of power conversion cells are connected in series for each of a plurality of phases is known, and the predetermined number is two or more (see Patent Document 1).

Patent Document 1 discloses a method in which, even if a power conversion cell of a certain phase becomes unavailable due to a failure or the like, the number of power conversion cells used in a target phase and the number of power conversion cells used in other phases remain in a state of inconsistency, and a balanced state of voltage between lines is maintained to continue outputting an AC voltage.

### RELATED-ART DOCUMENT

### PATENT DOCUMENT

Patent Document 1: Japanese Patent No. 4553167

In the multilevel power converter, a phase disposition (PD) method (also referred to as a “level shift system”) may be employed for each predetermined number of power conversion cells, in which the power conversion cells are driven based on a comparison between a voltage command value and carrier waves (triangular waves) having the same frequency and phase with shifted voltage levels.

However, when the PD method is employed, if the power conversion cell of a certain phase becomes unavailable and the number of power conversion cells used in a target phase does not match the number of power conversion cells used in other phases, it becomes necessary to increase the switching frequency of the target phase.

In view of the above problem, an object is to provide a technique capable of suppressing the switching frequency of the power conversion cells driven by the PD method in a multilevel power converter in which output units of a plurality of power conversion cells are connected in series for each of a plurality of phases.

### SUMMARY OF THE INVENTION

A power converter in one embodiment of the present disclosure includes:

a controller; and

a plurality of single-phase AC output units for respective phases, each of the plurality of single-phase AC output units being configured to output single-phase AC and including a predetermined number of power conversion cells,

wherein the predetermined number is two or more,

wherein each of the power conversion cells is configured to:

convert power supplied from an external power supply into single-phase AC of a predetermined voltage and frequency, and

output the single-phase AC,

wherein output units of the predetermined number of the power conversion cells are connected in series to enable outputs of the predetermined number of the power conversion cells to be superimposed to output the single-phase AC,

wherein each power conversion cell of the predetermined number of the power conversion cells includes a short circuit configured to short-circuit an output unit of the power conversion cell,

wherein a short circuit unit corresponding to a portion of the predetermined number of the power conversion cells is configured to be short-circuited such that outputs of remaining power conversion cells are superimposed to output the single-phase AC,

wherein, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise, and

wherein, when numbers of available power conversion cells for the plurality of single-phase AC output units are not all a same number, the controller is configured to selectively use:

a first control state in which each of the plurality of single-phase AC output units superimposes only outputs of a number of the power conversion cells corresponding to a minimum number of the numbers of available power conversion cells to output the single-phase AC, and

a second control state in which each of the plurality of single-phase AC output units superimposes outputs of all available power conversion cells to output the single-phase AC such that phase differences between line-to-line voltages of adjacent phases among the phases are all equivalent

A controller in another embodiment of the present disclosure is provided, the controller being configured to control a power converter including:

a plurality of single-phase AC output units for respective phases, each of the plurality of single-phase AC output units being configured to output single-phase AC and including a predetermined number of power conversion cells,

wherein the predetermined number is two or more,

wherein each of the power conversion cells is configured to:

convert power supplied from an external power supply into single-phase AC of a predetermined voltage and frequency, and

output the single-phase AC,

wherein output units of the predetermined number of the power conversion cells are connected in series to enable outputs of the predetermined number of the power conversion cells to be superimposed to output the single-phase AC,

wherein each power conversion cell of the predetermined number of the power conversion cells includes a short circuit configured to short-circuit an output unit of the power conversion cell, and

wherein, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise. The controller includes:

circuitry configured to,

for each of the plurality of single-phase AC output units, drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise, and

selectively use, when numbers of available power conversion cells for the plurality of single-phase AC output units are not all a same number,

a first control state in which each of the plurality of single-phase AC output units superimposes only outputs of a number of the power conversion cells corresponding to a minimum number of the numbers of available power conversion cells to output the single-phase AC, and

a second control state in which each of the plurality of single-phase AC output units superimposes outputs of all available power conversion cells to output the single-phase AC such that phase differences between line-to-line voltages of adjacent phases among the phases are all equivalent.

In still another embodiment of the present disclosure, a control method for a power converter is provided, the power converter including:

a plurality of single-phase AC output units for respective phases, each of the plurality of single-phase AC output units being configured to output single-phase AC and including a predetermined number of power conversion cells,

wherein the predetermined number is two or more,

wherein each of the power conversion cells is configured to:

convert power supplied from an external power supply into single-phase AC of a predetermined voltage and frequency, and

output the single-phase AC,

wherein output units of the predetermined number of the power conversion cells are connected in series to enable outputs of the predetermined number of the power conversion cells to be superimposed to output the single-phase AC,

wherein each power conversion cell of the predetermined number of the power conversion cells includes a short circuit configured to short-circuit an output unit of the power conversion cell, and

wherein, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise. The controller includes:

for each of the plurality of single-phase AC output units,

driving each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise; and

selectively using, when numbers of available power conversion cells for the plurality of single-phase AC output units are not all a same number,

a first control state in which each of the plurality of single-phase AC output units superimposes only outputs of a number of the power conversion cells corresponding to a minimum number of the numbers of available power conversion cells to output the single-phase AC, and

a second control state in which each of the plurality of single-phase AC output units superimposes outputs of all available power conversion cells to output the single-phase AC such that phase differences between line-to-line voltages of adjacent phases among the phases are all equivalent.

### BRIEF DESCRIPTION OF THE DRAWINGS

FIG. 1 is a diagram showing a configuration example of a drive system.

FIG. 2 is a diagram showing a configuration example of a power conversion cell.

FIG. 3 is a diagram showing a configuration example of a control system of a power converter.

FIGS. 4A and 4B are diagrams showing a specific example of a carrier waveform.

FIGS. 5A and 5B are diagrams showing a specific example of a modulation method.

FIGS. 6A and 6B are diagrams for describing an example of an operating state of the power converter.

FIGS. 7A and 7B are diagrams for describing an example of a control method (cell balance mode) of the power converter when there is an unavailable power conversion cell.

FIG. 8 is a diagram illustrating an example of the control method of an available and unavailable power conversion cell (surplus cell) in a cell balance mode.

FIGS. 9A and 9B are diagrams for describing another example of the control method (cell imbalance mode) of the power converter when there is an unavailable power conversion cell.

FIG. 10 is a flowchart schematically illustrating an example of a modulation scheme switching method.

FIG. 11 is a flowchart schematically illustrating an example of a control process for the power converter when there is an unavailable power conversion cell.

FIG. 12 is a timing chart illustrating an example of the operation of the power converter when there is the unavailable power conversion cell.

### DESCRIPTION OF THE PREFERRED EMBODIMENTS

Hereinafter, embodiments will be described with reference to the drawings.

### Configuration of Drive System

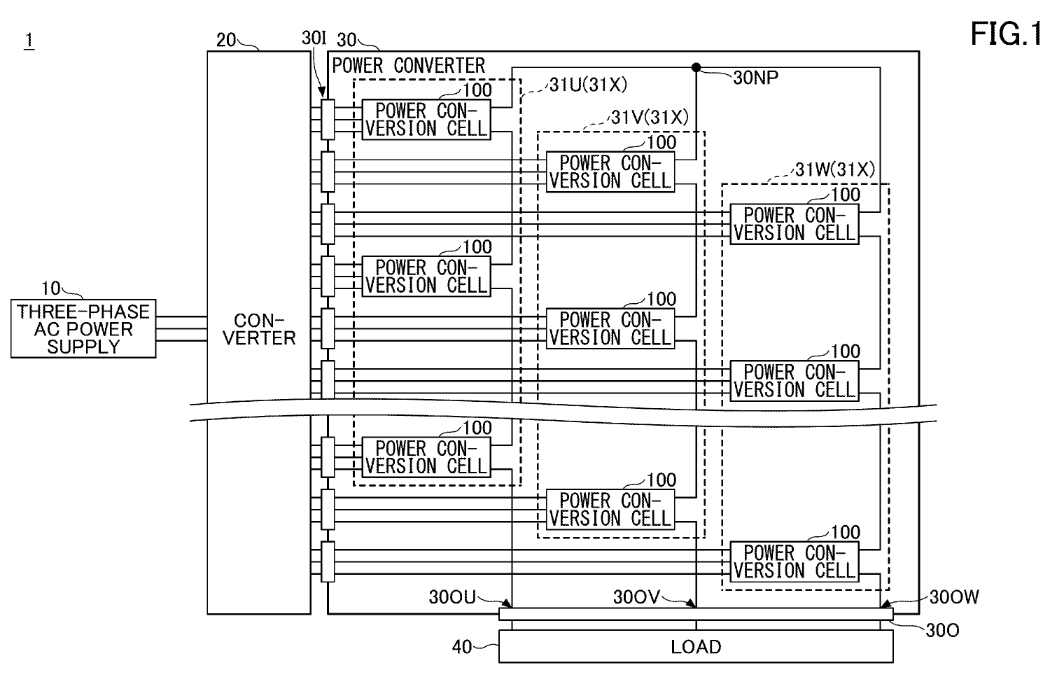

The configuration of a drive system 1 including a power converter 30 according to the present embodiment will be described with reference to FIG. 1.

FIG. 1 is a diagram showing a configuration example of the drive system 1.

As shown in FIG. 1, the drive system 1 includes a three-phase AC power supply 10, a converter 20, a power converter 30, and a load 40.

The three-phase AC power supply 10 supplies three-phase AC to the converter 20.

The converter 20 converts the three-phase AC supplied from the three-phase AC power supply 10 into a plurality of sets of three-phase AC, and outputs these sets. The plurality of sets of three-phase AC are supplied to the power converter 30. For example, the converter 20 is a multiphase transformer.

The power converter 30 converts the plurality of sets of three-phase AC supplied from the converter 20 into three-phase AC of a predetermined frequency and voltage, specifically U-phase, V-phase, and W-phase AC, and outputs the three-phase AC. The three-phase AC supplied from the power converter 30 is supplied to the load 40. In this arrangement, the power converter 30 can drive the load 40.

The load 40 operates by the three-phase AC supplied from the power converter 30. The load 40 is, for example, an induction motor or a synchronous motor.

### Configuration of Power Converter

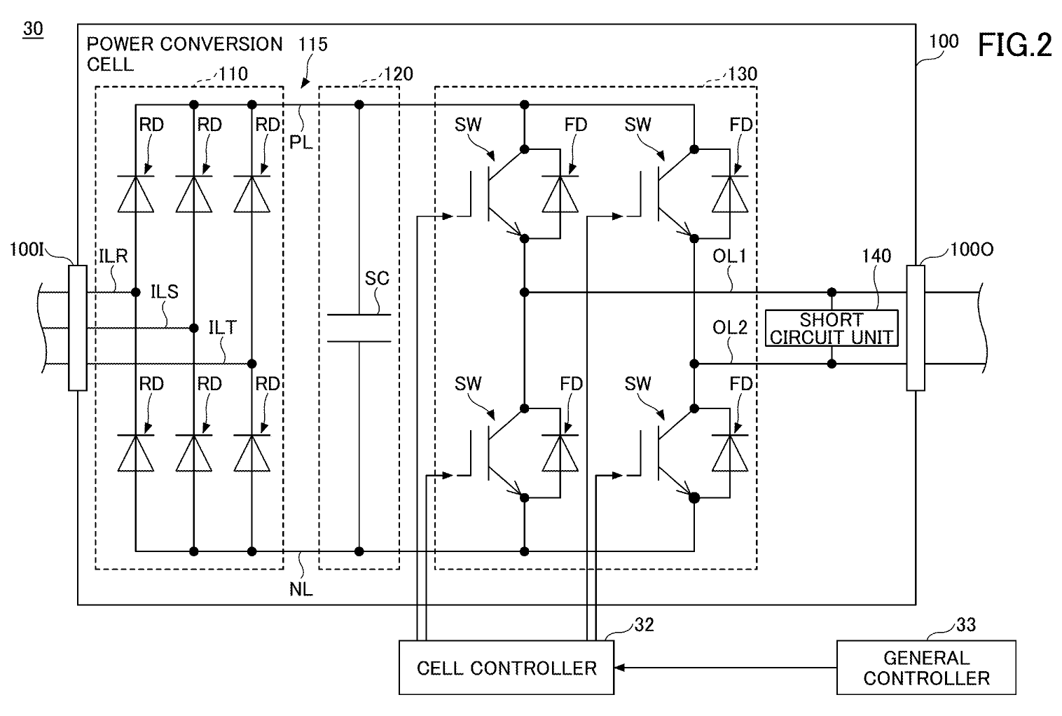

The configuration of the power converter 30 according to this embodiment will be described with reference to FIGS. 2 to 5 in addition to FIG. 1.

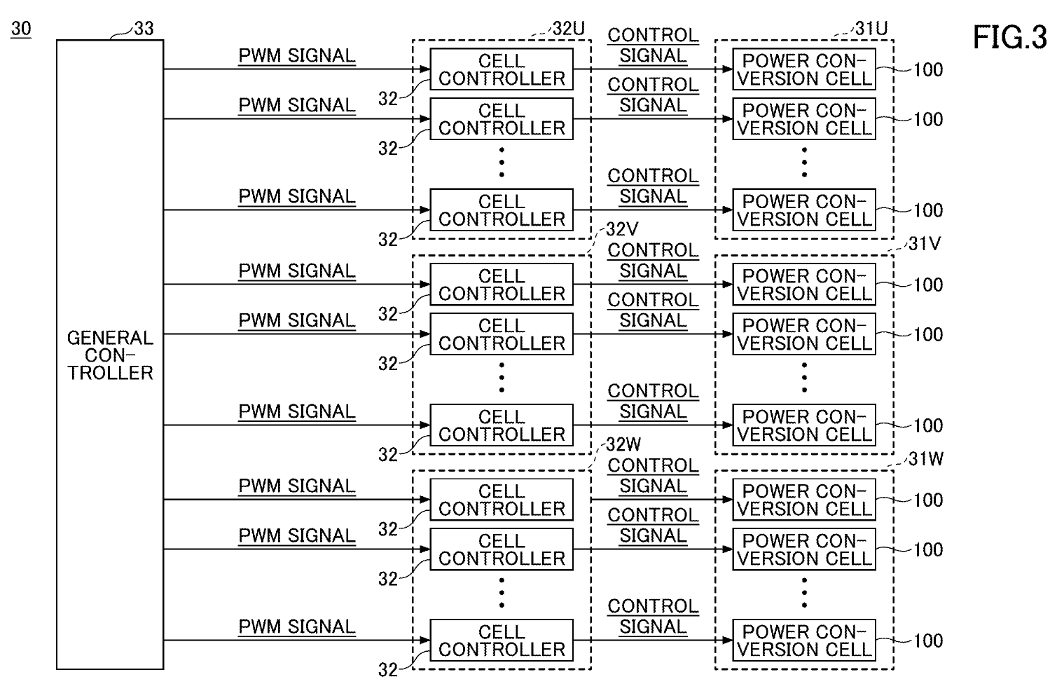

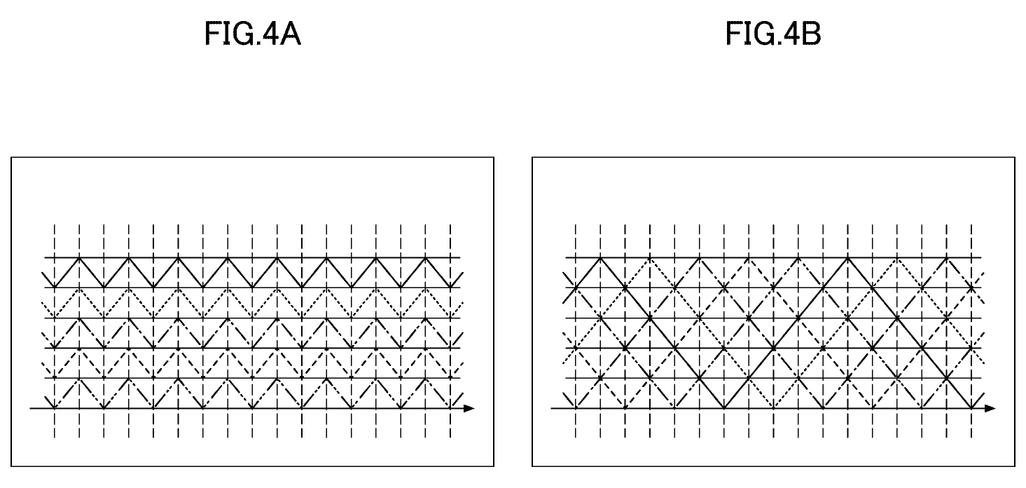

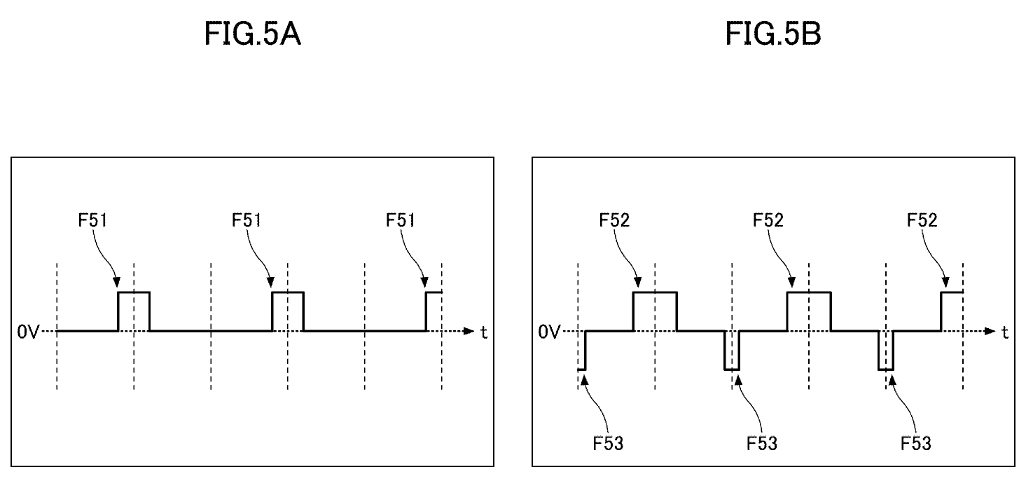

FIG. 2 is a diagram showing a configuration example of a power converter cell 100. FIG. 3 is a diagram showing a configuration example of a control system of the power converter 30. FIGS. 4A and 4B are diagrams showing specific examples of carrier waveforms. FIG. 4A shows an example of the carrier waveform according to the embodiment, and FIG. 4B shows the carrier waveform according to a comparative example. FIGS. 5A and 5B are diagrams showing specific examples of modulation schemes. FIG. 5A shows an example of the modulation scheme, and FIG. 5B shows another example of the modulation scheme.

As shown in FIGS. 1 to 3, the power converter 30 includes a plurality of input units 30I, an output unit 30O, a U-phase AC output unit 31U, a V-phase AC output unit 31V, a W-phase AC output unit 31W, a cell controller 32, and a general controller 33.

The plurality of sets of three-phase AC supplied from the converter 20 are input to the plurality of input units 30I. That is, the respective input units 30I receive the sets of three-phase AC supplied from the converter 20.

The output unit 30O outputs the three-phase AC generated by the power converter 30 to the outside. The output unit 30O is electrically connected to the load 40 outside the power converter 30. The output unit 30O includes a U-phase output unit 30OU for outputting the U-phase AC, a V-phase output unit 30OV for outputting the V-phase AC, and a W-phase output unit 30OW for outputting the W-phase AC.

The U-phase AC output unit 31U outputs the U-phase AC based on the three-phase AC input to the input unit 30I. The U-phase AC output unit 31U is electrically connected to the U-phase output unit 30OU inside the power converter 30.

The V-phase AC output unit 31V outputs the V-phase AC based on the three-phase AC input to the input unit 30I. The V-phase AC output unit 31V is electrically connected to the V-phase output unit 30OV inside the power converter 30.

The W-phase AC output unit 31W outputs the W-phase AC based on the three-phase AC input to the input unit 30I. The W-phase AC output unit 31W is electrically connected to the W-phase output unit 30OW inside the power converter 30.

Hereinafter, when the U-phase AC output unit 31U, the V-phase AC output unit 31V, and the W-phase AC output unit 31W are collectively referred to without distinction, these may be referred to as “single-phase AC output units 31X” for convenience.

The U-phase AC output unit 31U includes N (N is an integer greater than or equal to 2) power conversion cells 100.

In the U-phase AC output unit 31U, the three-phase AC is input to the N power conversion cells 100 from the N input units 30I, respectively. In the U-phase AC output unit 31U, each of the N power conversion cells 100 converts the three-phase AC input from the corresponding input unit 30I into single-phase AC having a predetermined voltage and frequency, and outputs the single-phase AC.

The V-phase AC output unit 31V includes N power conversion cells 100, the same as the U-phase AC output unit 31U.

In the V-phase AC output unit 31V, the three-phase AC is input to the N power conversion cells 100 from the N input units 30I, respectively, as in the case of the U-phase AC output unit 31U. In the V-phase AC output unit 31V, each of the N power conversion cells 100 converts the three-phase AC input from the corresponding input unit 30I into single-phase AC having a predetermined voltage and frequency, and outputs the single phase AC.

The W-phase AC output unit 31W includes N power conversion cells 100, the same number as in each of the U-phase AC output unit 31U and the V-phase AC output unit 31V.

In the W-phase AC output unit 31W, the three-phase AC is input to the N power conversion cells 100 from the N input units 30I, respectively, as in the case of the U-phase AC output unit 31U and the V-phase AC output unit 31V. In the W-phase AC output unit 31W, each of the N power conversion cells 100 converts the three-phase alternating current input from the corresponding input unit 30I into single phase AC having a predetermined voltage and frequency, and outputs the single phase AC.

Since all of (3×N) power conversion cells 100 included in the power converter 30 have the same configuration and the same specifications, the configuration of one power conversion cell 100 will be described representatively.

For example, as shown in FIG. 2, the power conversion cell 100 includes an input unit 100I, an output unit 100O, a rectifier unit 110, a DC link unit 115, a smoothing unit 120, an inverter unit 130, and a short circuit unit 140.

The input unit 100I is electrically connected to the input unit 30I, and the three-phase AC supplied from the converter 20 is input to the input unit 100I through the input unit 30I. In other words, the input unit 100I receives the three-phase AC from the converter 20 through the input unit 100I.

The output unit 100O outputs the single-phase AC that is generated by the power conversion cell 100.

The rectifier unit 110 converts the three-phase AC input through the input unit 100I into DC and outputs the DC to the DC link unit 115.

The DC link unit 115 electrically connects the rectifier unit 110 and the inverter unit 130. The DC link unit 115 includes a positive line PL and a negative line NL.

The smoothing unit 120 smoothes the DC of the DC link unit 115.

The inverter unit 130 converts the DC in the DC link unit 115, smoothed by the smoothing unit 120 into single-phase AC having a predetermined voltage and frequency and outputs the single-phase AC to the outside through the output unit 100O.

For example, as shown in FIG. 2, the rectifier unit 110 includes, for example, a diode bridge circuit. The diode bridge circuit is a bridge full-wave rectifier circuit, and includes input lines ILR, ILS, ILT and six rectifying diodes RD.

The input line ILR, the input line ILS, and the input line ILT are respectively supplied with three-phase AC of R-phase, S-phase, and T-phase through the input unit 100I.

The diode bridge circuit includes three sets of series-connected units (legs) of two rectifying diodes RD, and the three sets of legs are connected in parallel between the positive line PL and the negative line NL such that a forward direction of each rectifying diode RD is from the negative line NL to the positive line PL. Ends of the input lines ILR, ILS, and ILT are each connected to a middle point between two rectifying diodes RD in a corresponding set among the three sets of legs.

For example, as shown in FIG. 2, the smoothing unit 120 includes a smoothing capacitor SC.

One of two electrodes of the smoothing capacitor SC is electrically connected to the positive line PL, and power of the other electrode is electrically connected to the negative line. The smoothing capacitor SC suppresses and smooths DC ripple in the DC link unit 115 by appropriately repeating charging and discharging.

For example, as shown in FIG. 2, one smoothing capacitor SC is provided. Alternatively, a plurality of smoothing capacitors SC may be provided. In the latter case, the plurality of smoothing capacitors SC may be connected in parallel or in series between the positive line PL and the negative line NL. Further, the plurality of smoothing capacitors SC may be provided in such a manner that two or more series-connected units of smoothing capacitors SC are connected in parallel between the positive line PL and the negative line NL.

Further, the smoothing unit 120 may be provided with a reactor in addition to the smoothing capacitor SC. The reactor is provided, for example, in the positive line PL, and smooths the direct current of the direct current link unit 115 while generating a voltage so as to prevent a change in the current as appropriate.

For example, as shown in FIG. 2, the inverter unit 130 includes a full-bridge inverter circuit. The full-bridge inverter circuit includes four semiconductor switches SW, four freewheeling diodes FD, and output lines OL1 and OL2.

The full-bridge inverter circuit includes two sets of series-connected units (switch legs) of two semiconductor switches SW, and the two sets of switch legs are connected in parallel between the positive line PL and the negative line NL.

The semiconductor switches SW are each composed of, for example, silicon (Si) as a main material. The semiconductor switch SW may be composed of a wide band gap semiconductor material as a main material. The wide band gap semiconductor material is, for example, silicon carbide (SiC), gallium nitride (GaN), gallium oxide (Ga₂O₃₎, carbon (diamond: C), or the like.

Each freewheeling diode FD is connected in parallel with the semiconductor switch SW such that the forward direction is from the negative line NL to the positive line PL.

The output lines OL1 and OL2 output single-phase AC having a predetermined voltage and frequency, generated by the full-bridge inverter circuit, to the outside through the output unit 100O. The output line OL1 is drawn out from a midpoint of two semiconductor switches SW (i.e., upper and lower arms) in one of the two sets of switch legs and is electrically connected to the output unit 100O. The output line OL2 is drawn out from a midpoint of two semiconductor switches SW (upper and lower arms) in the other of the two sets of switch legs and is electrically connected to the output unit 100O.

The short circuit unit 140 switches the output lines OL1 and OL2 between an electrically disconnected state and an electrically connected short-circuit state. In this arrangement, the short circuit unit 140 can short-circuit the output lines OL1 and OL2. By short-circuiting the output lines OL1 and OL2, the short circuit unit 140 can prevent the voltage output from the power conversion cell 100. Hereinafter, description will be provided on the assumption that the short circuit unit 140 is in a disconnected state unless otherwise specified.

In the single-phase AC output unit 31X, the output units 100O of N power conversion cells 100 are connected in series. Hereinafter, the N power conversion cells 100 whose output units 100O are connected in series may be referred to as a “first stage power conversion cell 100,” a “second stage power conversion cell 100,”..., and an “Nth stage power conversion cell 100,” starting from the power conversion cell 100 farthest from the load 40.

In the first stage power conversion cell 100, the output line OL1 is connected to a neutral point 30NP through the output unit 100O, and the output line OL2 is connected to the output line OL1 of the second stage power conversion cell 100 through the output unit 100O.

In the second to (N−1)th stage power conversion cells 100, the output line OL1 is connected to the output line OL2 of the preceding stage power conversion cell 100, and the output line OL2 is connected to the output line OL1 of the succeeding stage power conversion cell 100.

In the Nth stage power conversion cell 100, the output line OL1 is connected to the output line OL2 of the (N−1)th stage power conversion cell 100 through the output unit 100O, and the output line OL2 is connected to the output unit 30O through the output unit 100O. Specifically, the output line OL2 of the Nth stage power conversion cell 100 in the U-phase AC output unit 31U is connected to the U-phase output unit 30OU, the output line OL2 of the Nth stage power conversion cell 100 in the V-phase AC output unit 31V is connected to the V-phase output unit 30OV, and the output line OL2 of the Nth stage power conversion cell 100 in the W-phase AC output unit 31W is connected to the W-phase output unit 30OW.

By connecting the output units 100O of the N power conversion cells 100 in series, thereby superimposing the outputs of the power conversion cells 100, the single-phase AC output unit 31X can output a relatively high voltage of single-phase AC (specifically, U-phase, V-phase, or W-phase AC).

When a portion of the power conversion cells 100 among the N power conversion cells 100 is unavailable, the single-phase AC output unit 31X can output single-phase AC (specifically, U-phase, V-phase, or W-phase AC) by short-circuiting the short-circuit units 140 of the unavailable power conversion cells 100, thereby sequentially superimposing the outputs of the remaining power conversion cells 100.

The use of the power conversion cell 100 means a state in which a voltage corresponding to a voltage command value is output from the power conversion cell 100. A case in which the power conversion cell 100 is unavailable includes, for example, a case in which an abnormality occurs in the power conversion cell 100 in which a normal operation cannot be continued (i.e., a failure) or a case in which the operation is preferably temporarily stopped (e.g., an overheating condition or the like). A case in which the power conversion cell 100 is unavailable may include, for example, a case in which a predetermined maintenance operation is performed on the power conversion cell 100 or a maintenance operation is suddenly required for some reason.

Hereinafter, a case in which five power conversion cells 100 are connected in series in the single-phase AC output unit 31X (that is, if N = 5) will be described as a specific example (see FIGS. 4 and 6-8).

The cell controller 32 is provided for each (3×N) of power conversion cells 100, and drives and controls a target power conversion cell 100 under the control of the general controller 33.

As shown in FIG. 3, among the (3×N) cell controllers 32, a group of N cell controllers 32 for controlling the power conversion cells 100 included in the U-phase AC output unit 31U may be referred to as “U-phase controllers 32U.” Among the (3×N) cell controllers 32, a group of N cell controllers 32 for controlling the power conversion cells 100 included in the V-phase AC output unit 31V may be referred to as “V-phase controllers 32 V.” Similarly, among the (3×N) cell controllers 32, a group of N cell controllers 32 for controlling the power conversion cells 100 included in the W-phase AC output unit 31W may be referred to as “W-phase controllers 32 W.”

The function of the cell controller 32 may be realized by any hardware or any combination of hardware and software. For example, the cell controller 32 is configured mainly by a computer including a processor, a memory device, an auxiliary memory device, and an interface device.

The general controller 33 controls the (3×N) cell controllers 32 and controls the operation of the individual power conversion cells 100 through the cell controller 32, thereby controlling the overall operation of the power converter 30.

The function of the general controller 33 is realized by arbitrary hardware or a combination of arbitrary hardware and software. For example, the general controller 33 is mainly composed of a computer including a processor, a memory device, an auxiliary memory device, and an interface device.

For example, as shown in FIG. 4A, in the present embodiment, for the N power conversion cells 100 connected in series, a phase disposition (PD) method is employed in which the power conversion cells 100 are driven based on a comparison between a voltage command value and N (in this example, five) triangular carrier waves as carrier waves having the same frequency and phase with shifted voltage levels. As a result, the single-phase AC output unit 31X can output the single-phase AC by stepwise superimposing the output voltages of the N power conversion cells 100.

For example, as shown in FIG. 4B, in the comparative example, a phase shift (PS) system is employed in which the power conversion cells 100 are driven based on a comparison between a voltage command value and N (in this example, five) triangular carrier waves as carrier waves having the same voltage amplitude and frequency but shifted phases. In the PS system, positive and negative inclinations of the respective carrier waves at the same time point may differ, and as a result, different switching operations (specifically, an operation in which the semiconductor switch SW of one phase turns on and the semiconductor switch SW of the other phase turns off) may occur simultaneously between the phases. Therefore, a voltage difference between voltages output from single-phase AC output units 31X of two adjacent phases occurs, that is, a two-level voltage change (so-called “two-level voltage jump”) occurs in a line-to-line voltage, and as a result, for example, insulation degradation of the load 40 may progress. In addition, harmonic components of the line-to-line voltage may become relatively large.

On the other hand, in the PD method, for the N power conversion cells 100, only one power conversion cell 100 performs a switching operation during one cycle of the carrier wave. Therefore, in the present embodiment, by adopting the PD method, it is possible to suppress two-level voltage change and harmonic components in the line-to-line voltage.

For example, as shown in FIG. 3, for the N power conversion cells 100 included in the U-phase AC output unit 31U, the general controller 33 compares N triangular waves having shifted voltage levels with a U-phase voltage command value Vu*, and generates PWM (Pulse Width Modulation) signals for driving the semiconductor switches SW of the N power conversion cells 100. Then, the general controller 33 outputs the respective PWM signals for the N power conversion cells 100 to the cell controllers 32 that control target power conversion cells 100 and that are included in the U-phase controller 32U.

For the N power conversion cells 100 included in the V-phase AC output unit 31V, the general controller 33 compares N triangular waves having shifted voltage levels with a V-phase voltage command value Vv*, and generates PWM signals for driving the semiconductor switches SW of the N power conversion cells 100. Then, the general controller 33 outputs the respective PWM signals for the N power conversion cells 100 to the cell controllers 32 that control target power conversion cells 100 and that are included in the V-phase controller 32V.

Similarly, the general controller 33 compares the N triangular waves having shifted voltage levels with a W-phase voltage command value Vw* for the N power conversion cells 100 included in the W-phase AC output unit 31W, and generates PWM signals for driving the semiconductor switches SW of the N power conversion cells 100. The general controller 33 then outputs the respective PWM signals for the N power conversion cells 100 to the cell controllers 32 that control target power conversion cells 100 and that are included in the W-phase controller 32W.

The general controller 33 converts the voltage command value into a pulse width and generates a PWM signal. At this time, in this embodiment, the general controller 33 selectively uses two modulation methods: unipolar modulation and bipolar modulation.

As shown in FIG. 5A, in the unipolar modulation, the PWM signal includes one ON signal F51 having a polarity corresponding to the voltage command value during one cycle. In other words, when using the unipolar modulation, the general controller 33 generates the PWM signal with the ON signal F51 having the polarity and pulse width, corresponding to the voltage command value.

As shown in FIG. 5B, in the bipolar modulation, the PWM signal includes both an ON signal F52 having a polarity corresponding to the voltage command value and a bias signal F53 having the opposite polarity during one cycle. In other words, when using the bipolar modulation, the general controller 33 generates the PWM signal including both: the ON signal F52 having (i) the polarity corresponding to the voltage command value and (ii) a pulse width obtained by adding the pulse width of the bias signal F53 to the pulse width corresponding to the voltage command value; and the bias signal F53 having the opposite polarity. In this arrangement, even when the voltage command value is relatively small and the pulse width corresponding to the voltage command value is less than the minimum ON/OFF time of the semiconductor switch SW, the power conversion cell 100 can appropriately operate in accordance with the voltage command value. In addition, since the pulse width corresponding to the voltage command value is realized by the superposition of the ON signal F52 and the bias signal F53, the power conversion cell 100 can more accurately output a voltage corresponding to the voltage command value, which is particularly preferable when the voltage command value is relatively small. On the other hand, in the bipolar modulation, the switching frequency of the power conversion cell 100 becomes twice that in the unipolar modulation.

Each of the N cell controllers 32 included in the U-phase controller 32U generates a control signal for controlling the switching of the semiconductor switches SW of the target power conversion cell 100 in accordance with the PWM signal that is input from the general controller 33, and outputs the control signal to the target power conversion cell 100. As a result, a voltage is applied from the drive circuit to a gate or a base of each semiconductor switch SW included in the power conversion cell 100, based on the control signal, and as a result, the semiconductor switch SW of the power conversion cell 100 can perform a switching operation in accordance with the PWM signal. Therefore, the U-phase AC output unit 31U can output the U-phase AC by stepwise superimposing the outputs of the N power conversion cells 100. Further, when short-circuit units 140 included in a portion of the power conversion cells 100 among the N power conversion cells 100 are in a short-circuited state, the U-phase AC output unit 31U can output the U-phase AC by stepwise superimposing the outputs of the remaining two or more power conversion cells 100.

Each of the N cell controllers 32 included in the V-phase controller 32V generates a control signal for controlling the switching of the semiconductor switches SW of the target power conversion cell 100 in accordance with the PWM signal that is input from the general controller 33, and outputs the control signal to the target power conversion cell 100. As a result, a voltage is applied from the drive circuit to a gate or a base of each semiconductor switch SW included in the power conversion cell 100, based on the control signal, and as a result, the semiconductor switch SW of the power conversion cell 100 can perform a switching operation in accordance with the PWM signal. Therefore, the V-phase AC output unit 31V can output the V-phase AC by stepwise superimposing the outputs of the N power conversion cells 100. When the short-circuit units 140 included in some of the power conversion cells 100 among the N power conversion cells 100 are in a short-circuited state, the V-phase AC output unit 31V can output a V-phase AC by stepwise superimposing the outputs of the remaining two or more power conversion cells 100.

Similarly, each of the N cell controllers 32 included in the W-phase controller 32W generates a control signal for controlling the switching of the semiconductor switches SW of the target power conversion cell 100 in accordance with the PWM signal that is input from the general controller 33, and outputs the control signal to the target power conversion cell 100. As a result, a voltage is applied from the drive circuit to a gate or a base of each semiconductor switch SW included in the power conversion cell 100, based on the control signal, and as a result, the semiconductor switch SW of the power conversion cell 100 can perform a switching operation in accordance with the PWM signal. Therefore, the W-phase AC output unit 31W can output W-phase AC by stepwise superimposing the outputs of the N power conversion cells 100. When the short-circuit units 140 included in a portion of the power conversion cells 100 among the N power conversion cells 100 are short-circuited, the W-phase AC output unit 31W can output a W-phase AC by stepwise superimposing the outputs of the remaining 2 or more power conversion cells 100.

### Basic Operating State of Power Converter

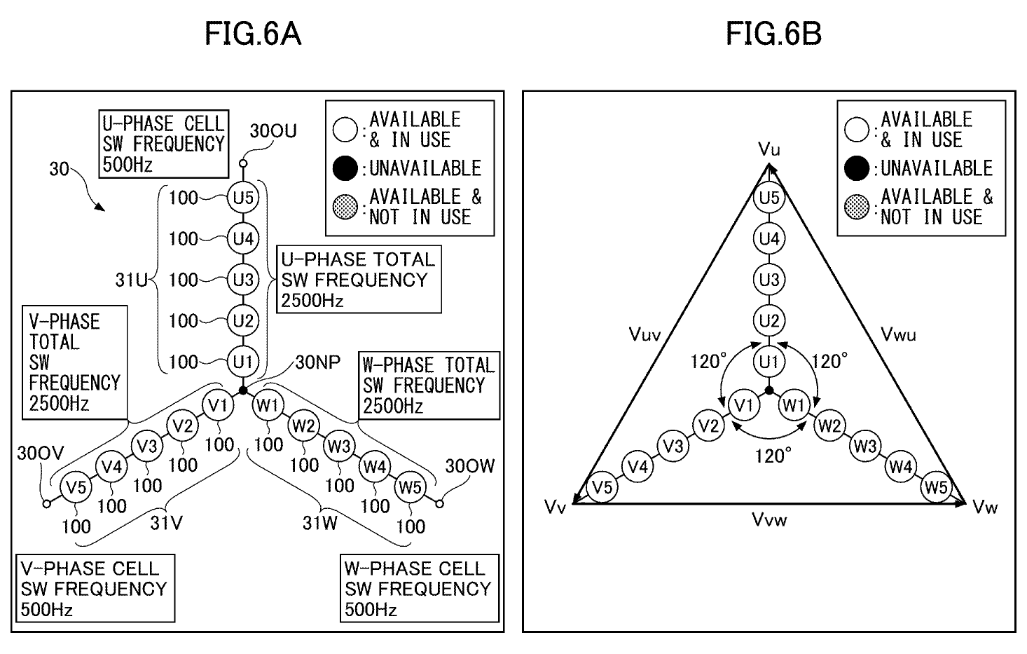

A basic operating state of the power converter 30 will be described with reference to FIG. 6. More specifically, the operating state of the power converter 30 when all power conversion cells 100 included in the power converter 30 are available and in use will be described.

FIGS. 6A and 6B are diagrams for describing an example of the operating state of the power converter 30. FIG. 6A is a diagram for describing an example of the switching frequency of the power conversion cell 100. FIG. 6B is a diagram showing an example of the magnitudes and phases of a U-phase voltage Vu, a V-phase voltage Vv, a W-phase voltage Vw, a UV line-to-line voltage Vuv, a VW line-to-line voltage Vvw, and a WU line-to-line voltage Vwu.

The U-phase voltage Vu is a phase voltage output from the U-phase AC output unit 31U. The V-phase voltage Vv is a phase voltage output from the V-phase AC output unit 31V. The W-phase voltage Vw is a phase voltage output from the W-phase AC output unit 31W. The UV line-to-line voltage Vuv is a voltage corresponding to a difference between the U-phase voltage Vu and the V-phase voltage Vv. The VW line-to-line voltage Vvw is a voltage corresponding to a difference between the V-phase voltage Vv and the W-phase voltage Vw. The WU line-to-line voltage Vwu is a voltage corresponding to a difference between the W-phase voltage Vw and the U-phase voltage Vu.

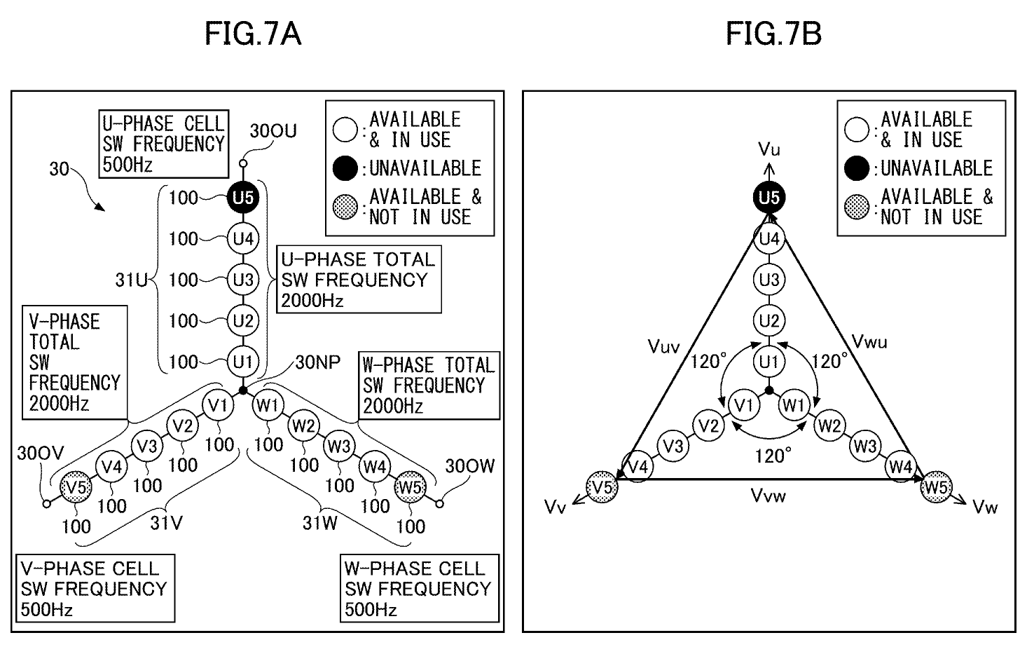

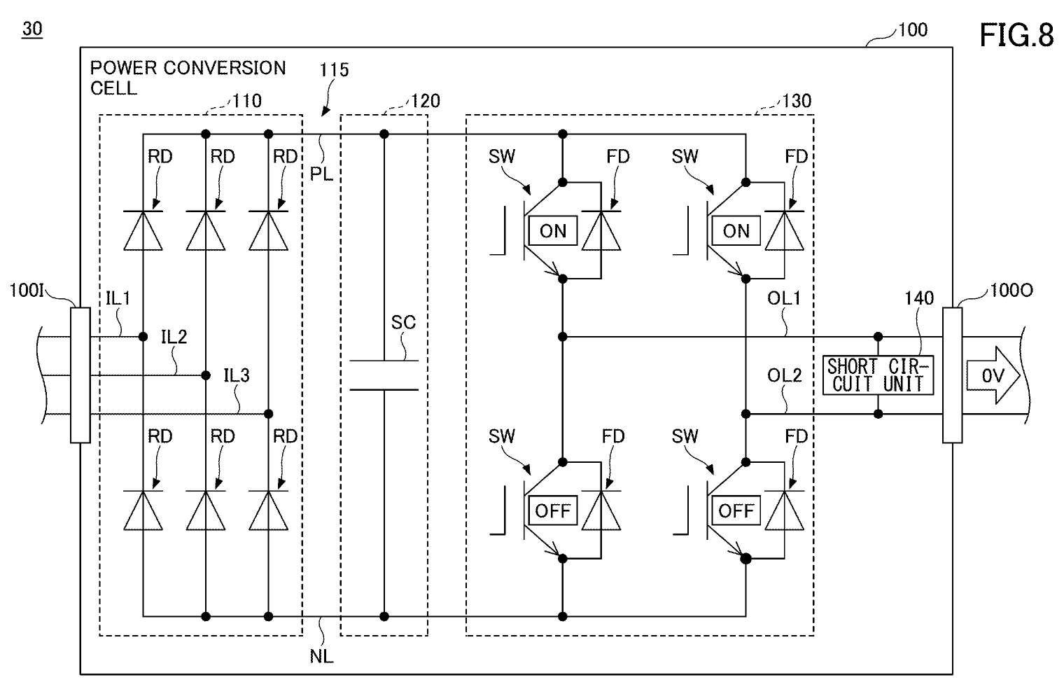

In this example, each of the U-phase AC output unit 31U, the V-phase AC output unit 31V, and the W-phase AC output unit 31W includes five power conversion cells 100 (i.e., N = 5). The same applies to FIGS. 7A, 7B, and 8, which will be described later. In this example, all power conversion cells 100 included in each of the U-phase AC output unit 31U, the V-phase AC output unit 31V, and the W-phase AC output unit 31W are available and in use.

When the PD method is employed, the total switching frequencies (hereinafter, for convenience, a “total switching frequency”) of the power conversion cells 100 in use included in the U-phase AC output unit 31U, the V-phase AC output unit 31V, and the W-phase AC output unit 31W need to be the same.

When all the power conversion cells included in the U-phase AC output unit 31U, the V-phase AC output unit 31V, and the W-phase AC output unit 31W are available and in use, the U-phase AC output unit 31U, the V-phase AC output unit 31V, and the W-phase AC output unit 31W use the same number (in this example, five) of power conversion cells 100 having the same specifications. In this case, as shown in FIG. 6 A, if the switching frequencies of the power conversion cells 100 included in the U-phase AC output unit 31U, the V-phase AC output unit 31V, and the W-phase AC output unit 31W are the same, the total switching frequencies automatically become the same. In this example, the switching frequency of the power conversion cells 100 included in the U-phase AC output unit 31U, the V-phase AC output unit 31V, and the W-phase AC output unit 31W is 500 Hz, and as a result, a total switching frequency is 2500 (= 500 × 5) Hz.

Further, since the U-phase AC output unit 31U, the V-phase AC output unit 31V, and the W-phase AC output unit 31W use the same number (in this example, five) of power conversion cells 100 having the same specifications, these output units can output voltages of the same magnitude. Therefore, as shown in FIG. 6B, the U-phase AC output unit 31U, the V-phase AC output unit 31V, and the W-phase AC output unit 31W are controlled by the general controller 33 such that the U-phase voltage Vu, the V-phase voltage Vv, and the W-phase voltage Vw have the same magnitude and the phase difference between adjacent phases is 120°. As a result, the general controller 33 controls the UV line-to-line voltage Vuv, the VW line-to-line voltage Vvw, and the WU line-to-line voltage Vwu such that the phase difference between adjacent lines is 120°, and a balanced state of the UV line-to-line voltage Vuv, the VW line-to-line voltage Vvw, and the WU line-to-line voltage Vwu can be realized. Therefore, the power converter 30 can appropriately drive the load 40 under the control of the general controller 33.

### Cell Balance Mode

Referring to FIGS. 7A, 7B, and 8, an example of a control method (cell balance mode) of the power converter 30 when there is an unavailable power conversion cell 100 will be described.

FIGS. 7A and 7B are diagrams for describing the example of the control method (cell balance mode) of the power converter 30 when there is an unavailable power conversion cell 100. FIG. 7A is a diagram for describing an example of the switching frequency of the power conversion cell 100 in the cell balance mode. FIG. 7B is a diagram showing an example of magnitudes and phases of the U-phase voltage Vu, V-phase voltage Vv, the W-phase voltage Vw, the UV line-to-line voltage Vuv, the VW line-to-line voltage Vvw, and the WU line-to-line voltage Vwu in the cell balance mode. FIG. 8 is a diagram showing an example of the method for controlling an available but unused power conversion cell (surplus cell) in the cell balance mode.

Hereinafter, description will be provided on the assumption that the short circuit unit 140 of the unavailable power conversion cell 100 is short-circuited and cannot output the voltage. In addition, unless otherwise specified, a case will be described in which there is an unavailable power conversion cell 100 and the number of available power conversion cells 100 of the U-phase AC output unit 31U, the V-phase AC output unit 31V, and the W-phase AC output unit 31W is not all the same.

The cell balance mode is an example of a control mode in which the general controller 33 controls the power conversion cell 100. In the cell balance mode, the general controller 33 aligns the number of power conversion cells 100 used by the U-phase AC output unit 31U, the V-phase AC output unit 31V, and the W-phase AC output unit 31W to the same number. Specifically, in the cell balance mode, the general controller 33 aligns the number of power conversion cells used by the U-phase AC output unit 31U, the V-phase AC output unit 31V, and the W-phase AC output unit 31W to a minimum number among the number of available power conversion cells 100 in each output unit. In this case, the general controller 33 intentionally disuses the number of available power conversion cells 100 corresponding to the difference from the minimum number, for any single-phase AC output unit 31X in which the number of available power conversion cells 100 among the U-phase AC output unit 31U, the V-phase AC output unit 31V, and the W-phase AC output unit 31W is not the minimum number. Hereinafter, in the cell balance mode, a power conversion cell 100 that intentionally remains unused although available may be referred to as a “surplus cell” for convenience.

For example, as shown in FIGS. 7A and 7B, all five power conversion cells 100 included in each of the V-phase AC output unit 31V and the W-phase AC output unit 31W are available. On the other hand, a power conversion cell 100 of the fifth-stage among the five power conversion cells 100 included in the U-phase AC output unit 31U is not available, and only the remaining four power conversion cells are available. Therefore, in the cell balance mode, the general controller 33 intentionally disables a number of power conversion cells 100 corresponding to a difference from the minimum number (in this example, one unit), for each of the V-phase AC output unit 31V and the W-phase AC output unit 31W, in which the number of available power conversion cells 100 is not a minimum number among the U-phase AC output unit 31U, the V-phase AC output unit 31V, and the W-phase AC output unit 31W. As a result, the general controller 33 can align the number of power conversion cells 100 used in each of the U-phase AC output unit 31U, the V-phase AC output unit 31V, and the W-phase AC output unit 31W with the number of available power conversion cells 100 in the U-phase AC output unit 31U (four cells).

For example, the surplus cell is fixed to a specific power conversion cell 100. Specifically, for example, as shown in FIG. 7A and 7B, the power conversion cell 100 in the fifth stage of each of the V-phase AC output unit 31V and the W-phase AC output unit 31W is set as the surplus cell. Further, the surplus cell may be changed appropriately. For example, for the single-phase AC output unit 31X including the surplus cell, the general controller 33 sequentially changes the surplus cell among the available power conversion cells 100 such that the switching frequencies among the available power conversion cells 100 are uniform.

For example, as shown in FIG. 8, in the surplus cell, under the control of the general controller 33 and the cell controller 32, semiconductor switches SW of both upper arms of two sets of switch legs are kept on, and semiconductor switches SW of both lower arms are kept off. As a result, a line-to-line voltage between the output lines OL1 and OL2 can be fixed at 0 V, and a state in which the surplus cell cannot be used can be realized.

As described above, when the PD method is employed, the total switching frequencies of the power conversion cells 100 in use included in the U-phase AC output unit 31U, the V-phase AC output unit 31V, and the W-phase AC output unit 31W need to be the same.

In the cell balance mode, the U-phase AC output unit 31U, the V-phase AC output unit 31V, and the W-phase AC output unit 31W each use the same number (in this example, four) of power conversion cells 100 having the same specifications. In this case, as shown in FIG. 7A, if the switching frequencies of the power conversion cells 100 included in the U-phase AC output unit 31U, the V-phase AC output unit 31V, and the W-phase AC output unit 31W are the same, total switching frequencies automatically become the same. In this example, the switching frequencies of the power conversion cells 100 included in the U-phase AC output unit 31U, the V-phase AC output unit 31V, and the W-phase AC output unit 31W are all 500 Hz, and as a result, the total switching frequency becomes the same at 2000 (= 500 × 4) Hz.

In the cell balance mode, the U-phase AC output unit 31U, the V-phase AC output unit 31V, and the W-phase AC output unit 31W each use the same number (In this example, four) of power conversion cells 100 having the same specifications, and thus these output units can output voltages of the same magnitude. Therefore, as shown in FIG. 7B, the U-phase AC output unit 31U, the V-phase AC output unit 31V, and the W-phase AC output unit 31W are controlled by the general controller 33 such that the U-phase voltage Vu, the V-phase voltage Vv, and the W-phase voltage Vw have the same magnitude and a phase difference of 120° between adjacent phases. As a result, the general controller 33 controls the UV line-to-line voltage Vuv, the VW line-to-line voltage Vvw, and the WU line-to-line voltage Vwu, such that these voltages have the same magnitude and a phase difference of 120° between the adjacent line-to-line voltages, thereby realizing a balanced state of the UV line-to-line voltage Vuv, the VW line-to-line voltage Vvw, and the WU line-to-line voltage Vwu. Therefore, the power converter 30 can appropriately drive the load 40 under the control of the general controller 33 in the cell balance mode.

As described above, by aligning the number of power conversion cells 100 used by the U-phase AC output unit 31U, the V-phase AC output unit 31V, and the W-phase AC output unit 31W, the general controller 33 can appropriately drive the load 40, although the output voltage drops from the maximum value.

There may be a case where unavailable power conversion cells 100 exist in all of the U-phase AC output unit 31U, the V-phase AC output unit 31V, and the W-phase AC output unit 31W, and the numbers of unavailable power conversion cells 100 are all the same. In this case, the U-phase AC output unit 31U, the V-phase AC output unit 31V, and the W-phase AC output unit 31W each use the same number of power conversion cells 100 having the same specifications. Therefore, except for the control of surplus cells, the general controller 33 can control the power conversion cells 100 of the U-phase AC output unit 31U, the V-phase AC output unit 31V, and the W-phase AC output unit 31W by the same control method as in the cell balance mode, and as a result, the power converter 30 can appropriately drive the load 40.

### Cell Imbalance Mode

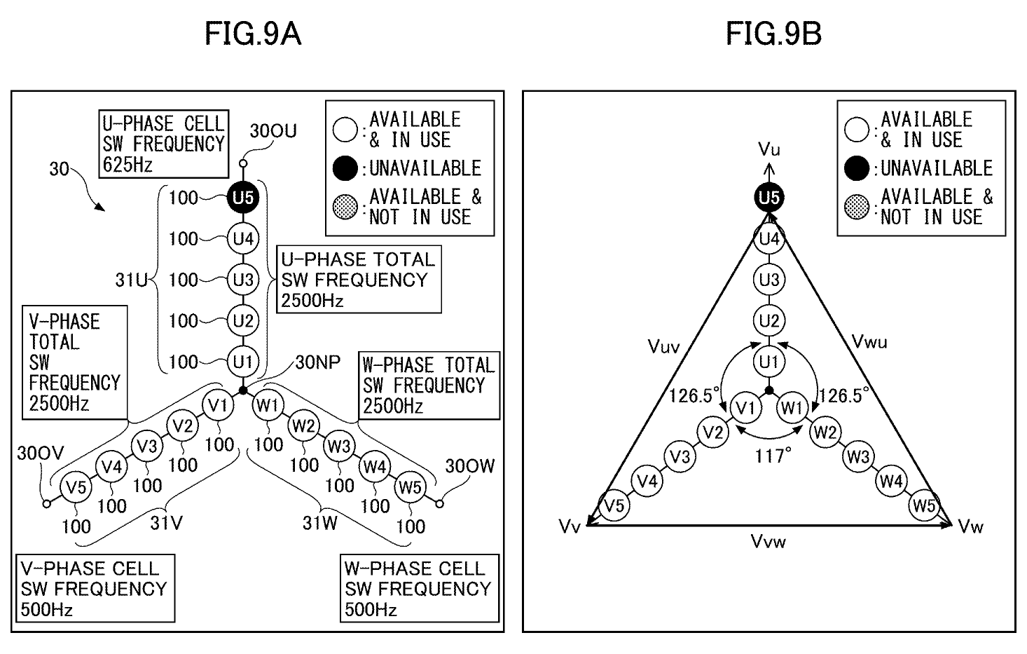

With reference to FIGS. 9A and 9B, another example (cell imbalance mode) of a control method of the power converter 30 when there is an unavailable power conversion cell 100 will be described.

FIGS. 9A and 9B are diagrams for describing another example (cell imbalance mode) of the control method of the power converter 30 when there is an unavailable power conversion cell 100. FIG. 9A is a diagram for describing an example of the switching frequency of the power conversion cell 100 in the cell imbalance mode. FIG. 9B is a diagram showing an example of the magnitudes and phases of the U-phase voltage Vu, the V-phase voltage Vv, the W-phase voltage Vw, the UV line-to-line voltage Vuv, the VW line-to-line voltage Vvw, and the WU line- to-line voltage Vwu in the cell imbalance mode.

Hereinafter, description will be provided on the assumption that the short circuit unit 140 of the unavailable power conversion cell 100 is short-circuited and cannot output a voltage. In addition, unless otherwise specified, a case will be described where there is the unavailable power conversion cell 100 and the numbers of available power conversion cells 100 of the U-phase AC output unit 31U, the V-phase AC output unit 31V, and the W-phase AC output unit 31W are not all the same.

In the cell imbalance mode, the general controller 33 uses all of the available power conversion cells 100 included in the power converter 30. Therefore, the numbers of power conversion cells 100 used by the U-phase AC output unit 31U, the V-phase AC output unit 31V, and the W-phase AC output unit 31W are not all the same.

For example, as shown in FIGS. 9A and 9B, all five power conversion cells 100 included in each of the V-phase AC output unit 31V and the W-phase AC output unit 31W are available. On the other hand, a power conversion cell 100 of the fifth-stage among the five power conversion cells 100 included in the U-phase AC output unit 31U is not available, and only the remaining four cells are available. Therefore, in the cell imbalance mode, the U-phase AC output unit 31U uses four power conversion cells 100 to output the U-phase AC, while the V-phase AC output unit 31V and the W-phase AC output unit 31W use five power conversion cells 100 to output the V-phase AC and the W-phase AC, respectively.

As described above, when the PD method is employed, the total switching frequencies of the power conversion cells 100 in use included in the U-phase AC output unit 31U, the V-phase AC output unit 31V, and the W-phase AC output unit 31W need to be the same.

In the cell imbalance mode, the numbers of the power conversion cells 100 used by the U-phase AC output unit 31U, the V-phase AC output unit 31V, and the W-phase AC output unit 31W are not all the same. Therefore, for the U-phase AC output unit 31U, the V-phase AC output unit 31V, and the W-phase AC output unit 31W, the fewer the available power conversion cells 100, the higher the switching frequency of the power conversion cells 100 becomes.

For example, as shown in FIG. 9A, since the V-phase AC output unit 31V and the W-phase AC output unit 31W can each use all five power conversion cells 100, the switching frequency of the power conversion cells 100 included in each of the output units is 500 Hz, as in the case of FIG. 7A. On the other hand, since the U- phase AC output unit 31U can use only four of the five power conversion cells 100, the switching frequency of the power conversion cells 100 included in the U-phase AC output unit 31U is 625 (= 500 × 5/4) Hz, which is higher than that of the V-phase AC output unit 31V and the W-phase AC output unit 31W.

In the cell imbalance mode, since the numbers of power conversion cells 100 used by the U-phase AC output unit 31U, the V-phase AC output unit 31V, and the W-phase AC output unit 31W are not all the same, the voltage magnitudes of the phases are not all the same. Therefore, the general controller 33 adjusts the phases of the U-phase voltage Vu, the V-phase voltage Vv, and the W-phase voltage Vw so that the UV line-to-line voltage Vuv, the VW line-to-line voltage Vvw, and the WU line-to-line voltage Vwu are in a balanced state, that is, a state where these voltages all have the same magnitude and phase differences between adjacent line-to-line voltages are all 120°.

For example, as shown in FIG. 9B, the general controller 33 controls the U-phase AC output unit 31U, the V-phase AC output unit 31V, and the W-phase AC output unit 31W such that the phase difference between the U-phase voltage Vu and each of the V-phase voltage Vv and the W-phase voltage Vw is 126.5° and the phase difference between the V-phase voltage Vv and the W-phase voltage Vw is 117°. As a result, the general controller 33 can realize a balanced state of the UV line-to-line voltage Vuv, the VW line-to-line voltage Vvw, and the WU line-to-line voltage Vwu. Therefore, the power converter 30 can appropriately drive the load 40 under the control of the general controller 33 in the cell imbalance mode.

In this manner, by appropriately adjusting the phase of the U-phase voltage Vu and the phases of the V-phase voltage Vv and the W-phase voltage Vw, the general controller 33 can appropriately drive the load 40 using all the available power converter cells 100.

### Method of Switching Modulation Systems

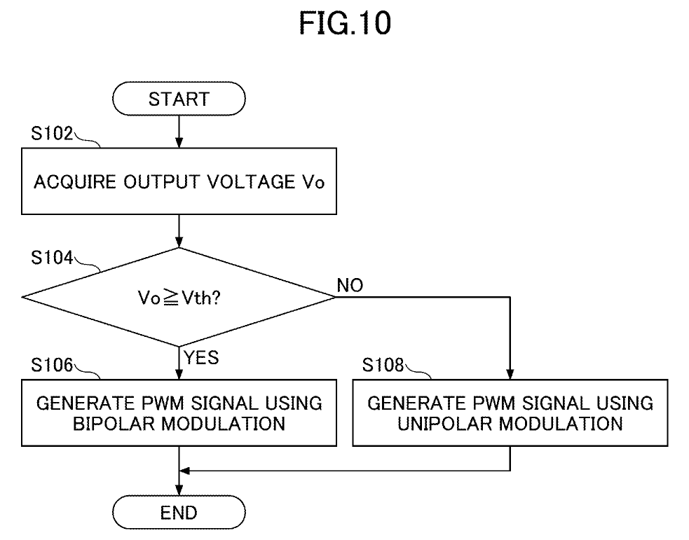

An example of a method of switching the modulation systems will be described with reference to FIG. 10.

FIG. 10 is a flowchart schematically showing an example of the method of switching modulation systems.

The flowchart of FIG. 10 is repeatedly executed at predetermined processing cycles when the power converter 30 is in operation.

As shown in FIG. 10, in step S102, the general controller 33 acquires the output voltage Vo of the power converter 30. The output voltage Vo of the power converter 30 is, for example, an effective value of a sine wave corresponding to the voltage command value V* of the power converter 30, and is set based on an operating condition of the load 40.

When the processing of step S102 is completed, the general controller 33 proceeds to step S104.

In step S104, the general controller 33 determines whether the output voltage Vo acquired in step S102 is equal to or greater than a threshold Vth. If the output voltage Vo is equal to or greater than the threshold Vth, the controller 33 proceeds to step S106, and if the output voltage Vo is less than the threshold Vth, the controller proceeds to step S108.

In step S104, the general controller 33 may determine whether the output voltage Vo is greater than the threshold Vth.

In step S106, the general controller 33 generates PWM signals for the power conversion cells 100 by bipolar modulation.

On the other hand, in step S108, the general controller 33 generates PWM signals for the power conversion cells 100 by unipolar modulation.

When the processing of step 106 or step 108 is completed, the general controller 33 ends the processing of the current flowchart.

As described above, the general controller 33 uses the unipolar modulation when the output voltage Vo of the power converter 30 is relatively large, and uses the bipolar modulation when the output voltage Vo of the power converter 30 is relatively small. As a result, the general controller 33 can improve the accuracy of the actual output voltage with respect to the voltage command value when the output voltage of the power converter 30 is relatively small, and can suppress the switching frequency when the output voltage of the power converter 30 is relatively large.

Control Processing of Power Converter When There is an Unavailable Power Conversion Cell

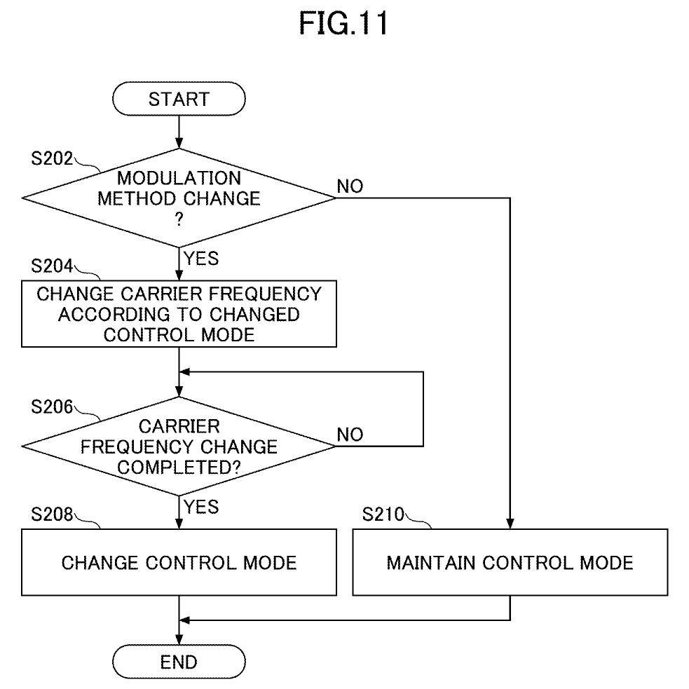

Control processing of the power converter 30 when there is an unavailable power conversion cell 100 will be described with reference to FIG. 11. Specifically, the control processing of the power converter 30 will be described for a case where there is an unavailable power conversion cell 100 and the numbers of available power conversion cells 100 in the U-phase AC output unit 31U, the V-phase AC output unit 31V, and the W-phase AC output unit 31W are not all the same.

Hereinafter, description will be provided on the assumption that in a case of unipolar modulation, the cell imbalance mode is used, and in a case of bipolar modulation, the cell balance mode is used.

FIG. 11 is a flowchart schematically showing an example of the control processing of the power conversion cells 100 when there is an unavailable power conversion cell 100.

The flowchart of FIG. 11 is repeatedly executed, for example, when there is an unavailable power conversion cell 100 and the numbers of available power conversion cells 100 in the U-phase AC output unit 31U, the V-phase AC output unit 31V, and the W-phase AC output unit 31W are not all the same.

As shown in FIG. 11, in step S202, the general controller 33 determines whether the modulation method has been changed in the most recent processing of the flowchart of FIG. 10. If the modulation method is changed, the general controller 33 proceeds to step S204, and proceeds to step S210 if the modulation method is not changed.

In step S204, the general controller 33 changes the carrier frequency of the power converter 30 to the total switching frequency of a predetermined phase in accordance with the changed control mode. The predetermined phase is, for example, a phase having a maximum total switching frequency in the cell imbalance mode among the U-phase, the V-phase, and the W-phase (that is, a phase having the maximum number of available power conversion cells 100 included in the single-phase AC output unit 31X).

For example, when the cell imbalance mode of FIGS. 7A and 7B is changed to the cell imbalance mode of FIGS. 9A and 9B, the general controller 33 increases the carrier frequency of the power converter 30 from 2000 Hz to 2500 Hz in order to increase the total switching frequency of each of the V-phase and the W-phase from the state of FIG. 7A (2000 Hz) to the state of FIG. 9A (2500 Hz). Further, for example, when the cell imbalance mode of FIG. 9A and 9B is changed to the cell balance mode of FIGS. 7A and 7B, the general controller 33 decreases the carrier frequency of the power converter 30 from 2500 Hz to 2000 Hz in order to decrease the total switching frequency of each of the V-phase and the W-phase from the state of FIG. 9A (2500 Hz) to the state of FIG. 7A (2000 Hz).

When the processing of step S204 is completed, the general controller 33 proceeds to step S206.

In step S206, the general controller 33 determines whether the change in the carrier frequency has been completed, that is, whether the carrier frequency has increased or decreased to a set value after the change. If the change in the carrier frequency has been completed, the general controller 33 proceeds to step S208. If the change in the carrier frequency has not been completed, the process of this step is repeated until the change in the carrier frequency has been completed.

In step S208, the general controller 33 changes the control mode.

As a result, the general controller 33 starts control of the power conversion cells 100 of the power converter 30 according to the changed control mode.

On the other hand, in step S210, the general controller 33 maintains the current control mode.

As a result, the general controller 33 continues the control of the power conversion cells 100 of the power converter 30 according to the current control mode.

When the processing of step S208 or step S210 is completed, the general controller 33 ends the processing of the present flowchart.

In this arrangement, in accordance with the change in the modulation method, the general controller 33 can switch the control mode so as to select the cell balance mode in a case of bipolar modulation and select the cell imbalance mode in a case of unipolar modulation. Therefore, the general controller 33 can suppress a situation where, for example, the bipolar modulation and the cell imbalance mode are selected in combination and the switching frequency of the semiconductor switches SW further increases, thereby suppressing the switching frequency of the semiconductor switches SW.

### Operation of Power Converter When There is an Unavailable Power Conversion Cell

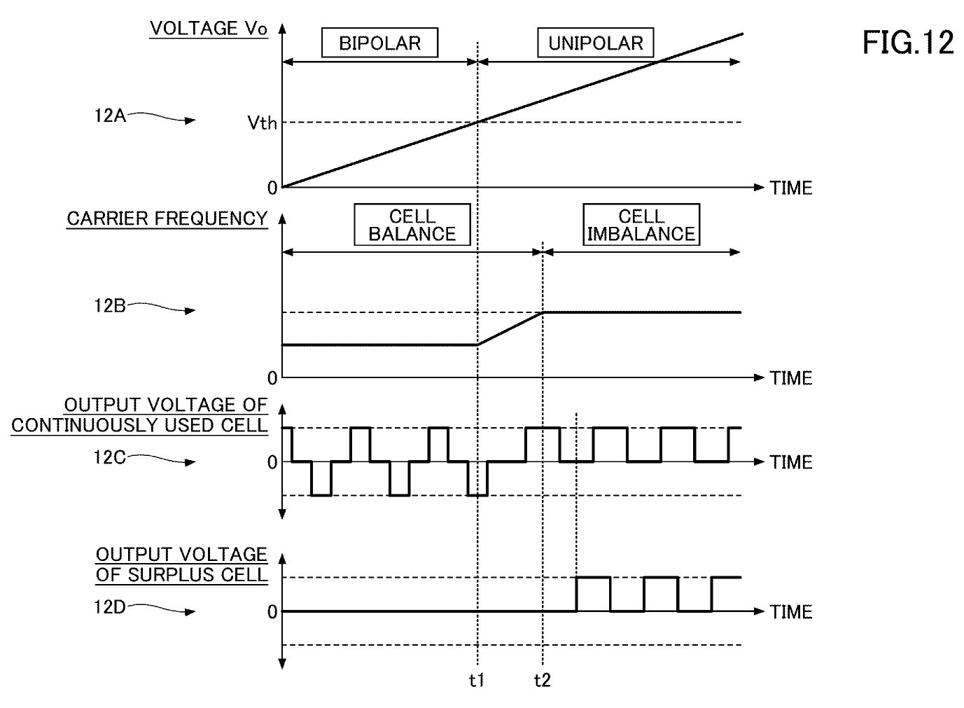

The operation of the power converter 30 when there is an unavailable power conversion cell 100 will be described with reference to FIGS. 12A, 12B, 12C, and 12D. Specifically, the operation of the power converter 30 when there is an unavailable power conversion cell 100 and the numbers of available power conversion cells 100 in the U-phase AC output unit 31U, the V-phase AC output unit 31V, and the W-phase AC output unit 31W are not all the same will be described.

FIG. 12 is a timing chart showing an example of the operation of the power converter 30 when there is the unavailable power conversion cell 100. FIG. 12A is a timing chart showing an example of the time change of the output voltage Vo of the power converter 30. FIG. 12B is a timing chart showing an example of the time change of the carrier frequency of the power conversion cell 100 included in a single-phase AC output unit 31X having a number of available power conversion cells 100 that is not a maximum among the U-phase AC output unit 31U, the V-phase AC output unit 31V, and the W-phase AC output unit 31W. FIG. 12C is a timing chart showing an example of the time change of the output voltage of the power conversion cell 100 (constantly used cell) used in both the cell balance mode and the cell imbalance mode among the available power conversion cells 100 included in the power converter 30. FIG. 12D is a timing chart showing an example of the time change of the output voltage of the power conversion cell 100 (surplus cell) that is set as unavailable in the cell balance mode among the available power conversion cells 100 included in the power converter 30.

As shown in FIG. 12A, in this example, the output voltage Vo of the power converter 30 increases linearly from 0 (zero), and a PWM signal is generated by bipolar modulation in a time range in which the output voltage Vo is less than a threshold Vth.

In a time range where the output voltage Vo is less than the threshold Vth, the power converter 30 is controlled in the cell balance mode corresponding to the bipolar modulation. Therefore, as shown in FIG. 12B, the carrier frequency of the power conversion cell 100 included in the single-phase AC output unit 31X having a number of available power conversion cells 100 that is not the maximum among the U-phase AC output unit 31U, the V-phase AC output unit 31V, and the W-phase AC output unit 31W is maintained at a relatively small set value.

At time t1, when the output voltage Vo reaches the threshold Vth, the modulation method switches from the bipolar modulation to the unipolar modulation (see FIG. 10), and after time t1, the PWM signal is generated by the unipolar modulation.

At time t1, when the modulation method switches from the bipolar modulation to the unipolar modulation, the carrier frequency of the power conversion cell 100 included in the single-phase AC output unit 31X having a number of available power conversion cells 100 that is not the maximum among the U-phase AC output unit 31U, the V-phase AC output unit 31V, and the W-phase AC output unit 31W is changed in an increasing direction in accordance with the cell imbalance mode corresponding to the unipolar modulation (see step S204 in FIG. 11). Then, at time t2 after time t1, when the carrier frequency of the power conversion cell 100 included in the single-phase AC output unit 31X having a number of available power conversion cells 100 that is not the maximum among the U-phase AC output unit 31U, the V-phase AC output unit 31V, and the W-phase AC output unit 31W reaches a set value corresponding to the cell imbalance mode, the control mode switches from the cell balance mode to the cell imbalance mode (see steps S206 and S208 in FIG. 11).

As shown in FIG. 12C, in the time range before time t1, since the PWM signal is output by the bipolar modulation, the constantly used cell outputs an ON voltage having a polarity corresponding to the voltage command value and a bias voltage having the opposite polarity. On the other hand, in the time range after time t1, since the PWM signal is output by the unipolar modulation, the constantly used cell outputs only the ON voltage having a polarity corresponding to the voltage command value.

Further, as shown in FIG. 12D, in the time range before time t2, since the cell balance mode is used, and the surplus cell is intentionally as unused, the output voltage of the surplus cell is maintained at 0 (zero). On the other hand, in the time range after time t2, since the cell imbalance mode is used, and the surplus cell is used, the surplus cell outputs the ON voltage having a polarity corresponding to the voltage command value based on the PWM signal by unipolar modulation.

### Other Embodiments

Other embodiments will be described.

The above embodiments may be modified or changed as appropriate. Hereinafter, examples in which modifications or changes are made to the embodiments will be referred to as “modifications” for convenience.

For example, in the above-mentioned embodiments, the modulation method may be fixed to either bipolar modulation or unipolar modulation. In this case, the general controller 33 may select the cell balance mode when the output voltage Vo is less than or equal to a predetermined threshold, and may select the cell imbalance mode when the output voltage Vo is greater than or equal to the threshold. In this case, the predetermined threshold may be the same as or different from the above threshold Vth.

Further, in the embodiments and modifications, in the cell balance mode, a surplus cell may be set as unused by placing the short circuit unit 140 in a short-circuited state.

Further, in the embodiments and modifications, the cell controller 32 and the general controller 33 may be provided outside the power converter 30.

Further, in the embodiments and modifications, the short circuit unit 140 may be provided outside the power conversion cell 100.

In the embodiments and modifications, the power converter 30 may output two-phase AC or AC of four or more phases instead of three-phase AC. That is, by including M (M is an integer of 2 or more) single-phase AC output units 31X, the power converter 30 can output M-phase (M is an integer greater than or equal to 2) AC.

### Operation

The operation of the power converter, the control device, and the control method according to the present embodiment will be described.

In a first aspect of the present embodiment, a power converter including a plurality of single-phase AC output units and a controller is provided. The power converter is, for example, the power converter 30 described above. The plurality of single-phase AC output units include, for example, the three-phase single-phase AC output unit 31X described above, that is, the U-phase AC output unit 31U, the V-phase AC output unit 31V, and the W-phase AC output unit 31W. The controller is, for example, the general controller 33 described above. Specifically, each of the plurality of single-phase AC output units output single-phase AC. Each single-phase AC output unit includes a predetermined number of the power conversion cells for converting power supplied from an external power supply into single-phase AC of a predetermined voltage and frequency, to output the single-phase AC converted from the power. The predetermined number is two or more. Output units of the predetermined number of the power conversion cells are connected in series such that outputs of the predetermined number of the power conversion cells can be superimposed to output the single-phase AC. The output units can be short-circuited for each of the predetermined number of the power conversion cells, and short circuit units corresponding to a portion among the predetermined number of the power conversion cells are short-circuited such that outputs of the remaining power conversion cells can be superimposed to output the single-phase AC. The external power supply is, for example, a converter 20. The power conversion cell is, for example, the power conversion cell 100 described above. The predetermined number is, for example, N as an integer of two or more as described above. The output unit of the power conversion cell is, for example, the output unit 100O described above. The short circuit unit is, for example, the short-circuit unit 140 described above. Further, the controller superimposes outputs of all or a portion of the predetermined number of power conversion cells in a stepwise manner by driving all or the portion of the predetermined number of power conversion cells based on a comparison between a voltage command value and triangular waves having the same frequency and the same phase with shifted voltage levels. When the number of available power conversion cells is not all a same number, the controller selectively uses: a first control state in which each of the single-phase AC output units superimposes only outputs of a number of the power conversion cells corresponding to a minimum number of the numbers of available power conversion cells to output the single-phase AC; and a second control state in which each of the plurality of single-phase AC output units superimposes outputs of all available power conversion cells to output the single-phase AC such that phase differences between line-to-line voltages of adjacent phases among phases are all equivalent. The first control state is, for example, the cell balance mode described above. The second control state is, for example, the cell imbalance mode described above.

In this arrangement, the power converter can use both a second control state in which the switching frequency of the available power conversion cell included in a single-phase AC output unit that includes an unavailable power conversion cell increases, and a first control state in which the switching frequency does not increase, under the premise that the power conversion cell 100 is driven by the PD method. Therefore, the power converter can suppress the switching frequency of the power conversion cells driven by the PD method.

In a second aspect of the present embodiment, on the premise of the first aspect described above, the controller may be configured to: drive the power conversion cells by unipolar modulation based on the comparison between the voltage command value and the triangular waves, and drive the power conversion cells by bipolar modulation based on the comparison between the voltage command value and the triangular waves. When the numbers of available power conversion cells for the plurality of single-phase AC output units are not the same number, the controller is configured to: use the second control state in a case of driving the power conversion cells by the unipolar modulation, and use the first control state in a case of driving the power conversion cells by the bipolar modulation.

In this arrangement, the power converter can prevent, for example, simultaneous selection of bipolar modulation in which the switching frequency of the single-phase AC output unit is twice that of unipolar modulation, and a second control state in which the switching frequency of the power conversion cell increases for the single-phase AC output unit in which the number of available power conversion cells among the single-phase AC output units of the plurality of phases is not a maximum. Therefore, the power converter can further suppress the switching frequency of the power conversion cells driven by the PD method, and as a result, it is possible to suppress an increase in cost from the viewpoint of durability and reliability with respect to the switching frequency. In addition, the power converter can suppress an increase in the amount of heat generated by the semiconductor switches as the switching frequency is suppressed, and as a result, the size of cooling devices such as heat sinks can be reduced, and the cost of the cooling devices can be suppressed.

In a third aspect of the present embodiment, on the premise of the first or second aspect described above, when the numbers of available power conversion cells for the plurality of single-phase AC output units are not the same number, the controller may be configured to: use the first control state upon occurrence of a condition in which the output voltages of the power conversion cells are each less than or equal to a threshold, and use the second control state upon occurrence of a condition in which an output voltage of the power converter is greater than or equal to a second threshold.

In this arrangement, in the first control state, some available power conversion cells are not used and the output is limited, but the power converter can suppress the influence of the output limitation by using the first control state when the output voltage is relatively small. Therefore, the power converter can suppress the switching frequency of the power conversion cells while suppressing the influence of the output limitation in the first control state.

In a fourth aspect of the present embodiment, on the premise of any one of the first to third aspects described above, in the first control state, for a single-phase AC output unit in which the number of available power conversion cells is greater than the minimum number, among the plurality of single-phase AC output units, the controller may be configured to control output voltages of the available power conversion cells exceeding the minimum number to zero, to cause only outputs of a number of the power conversion cells corresponding to the minimum number to be superimposed to output the single-phase AC. The available power conversion cells exceeding the minimum number is, for example, the surplus cell described above.

In this arrangement, the power converter can quickly switch between the first control state and the second control state.

In a fifth aspect of the present embodiment, on the premise of any one of the first to fourth aspects, in the first control state, for single-phase AC output units in which the number of available power conversion cells is greater than the minimum number, among the plurality of single-phase AC output units, the controller may be configured to switch off power conversion cells that do not contribute to the output voltage of a target single-phase AC output unit, among the available power conversion cells. The power conversion cells that do not contribute to the output voltage of a target single-phase AC output unit, among the available power conversion cells are, for example, the surplus cells.

In this arrangement, the power converter can suppress deviation in the number of switching operations among the available power conversion cells for a single-phase AC output unit in which the number of available power conversion cells is greater than a minimum number among a plurality of single-phase AC output units of a plurality of phases.

In a sixth aspect of the present embodiment, a controller configured to control a power converter is provided. The power converter includes a plurality of single-phase AC output units for respective phases, each of the plurality of single-phase AC output units being configured to output single-phase AC and including a predetermined number of power conversion cells. The predetermined number is two or more, and each of the power conversion cells is configured to: convert power supplied from an external power supply into single-phase AC of a predetermined voltage and frequency, and output the single-phase AC. Output units of the predetermined number of the power conversion cells are connected in series to enable outputs of the predetermined number of the power conversion cells to be superimposed to output the single-phase AC. Each power conversion cell of the predetermined number of the power conversion cells includes a short circuit configured to short-circuit an output unit of the power conversion cell, and for each of the plurality of single-phase AC output units, the controller is configured to drive each of all or a portion of the predetermined number of power conversion cells based on a comparison between a voltage command value and triangular waves having a same frequency and a same phase with shifted voltage levels, and to superimpose outputs of all or the portion of the predetermined number of power conversion cells to change stepwise. The control device is, for example, the general controller 33. Specifically, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of power conversion cells to change stepwise. The controller is configured to selectively use, when numbers of available power conversion cells for the plurality of phase single AC output units are not all identical, a first control state in which each of the plurality of single-phase AC output units superimposes only outputs of a number of the power conversion cells corresponding to a minimum number of the numbers of available power conversion cells to output the single-phase AC; and a second control state in which each of the plurality of single-phase AC output units superimposes outputs of all available power conversion cells to output the single-phase AC such that phase differences between line-to-line voltages of adjacent phases among the phases are all equal.

In this arrangement, the control device has the same operations and effects as those of the first aspect described above.

With respect to the control device, the same aspects as those of the second to fifth aspects of the power converter can be realized on the premise of the sixth aspect described above.

As a result, the control device has the same operations and effects as those of the second to fifth aspects described above.

In a seventh aspect of the present embodiment, a control method for a power converter is provided. The power converter includes a plurality of single-phase AC output units for respective phases, each of the plurality of single-phase AC output units being configured to output single-phase AC and including a predetermined number of power conversion cells. The predetermined number is two or more. Each of the power conversion cells is configured to: convert power supplied from an external power supply into single-phase AC of a predetermined voltage and frequency, and output the single-phase AC. Output units of the predetermined number of power conversion cells are connected in series to enable outputs of the predetermined number of the power conversion cells to be superimposed to output the single-phase AC. Each power conversion cell of the predetermined number of power conversion cells includes a short circuit configured to short-circuit an output unit of the power conversion cell. For each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise. The control method includes, for each of the plurality of single-phase AC output units, driving each of all or a portion of the predetermined number of the power conversion cells based on a comparison between a voltage command value and triangular waves having a same frequency and a same phase with shifted voltage levels, and to superimpose outputs of all or the portion of the predetermined number of power conversion cells to change stepwise; and selectively using, when numbers of available power conversion cells for the plurality of phase single AC output units are not all a same number, a first control state in which each of the plurality of single-phase AC output units superimposes only outputs of a number of the power conversion cells corresponding to a minimum number of the numbers of available power conversion cells to output the single-phase AC, and a second control state in which each of the plurality of single-phase AC output units superimposes outputs of all available power conversion cells to output the single-phase AC such that phase differences between line-to-line voltages of adjacent phases among the phases are all equal.

With this approach, the control method has the same operations and effects as those of the first aspect described above.

With respect to the control device, the same aspects as those of the second to fifth aspects of the power converter can be realized on the premise of the sixth aspect described above.

With regard to the control method, the same aspects as those of the second to fifth aspects of the power converter can be realized on the premise of the seventh aspect described above.

As a result, the control method has the same operations and effects as those of the second to fifth aspects described above.

Although the embodiments have been described in detail above, the present disclosure is not limited to the specific embodiments, and various modifications and changes can be made within the scope of the present disclosure.

In the present disclosure, a switching frequency of power conversion cells driven by a PD method in a multilevel power converter in which output units of a plurality of power conversion cells are connected in series for each of a plurality of phases can be suppressed.

What is claimed is:

1. A power converter comprising:
a controller; and
a plurality of single-phase AC output units for respective phases, each of the plurality of single-phase AC output units being configured to output single-phase AC and including a predetermined number of power conversion cells,
wherein the predetermined number is two or more,
wherein each of the power conversion cells is configured to:
convert power supplied from an external power supply into single-phase AC of a predetermined voltage and frequency, and
output the single-phase AC,
wherein output units of the predetermined number of the power conversion cells are connected in series to enable outputs of the predetermined number of the power conversion cells to be superimposed to output the single-phase AC,
wherein each power conversion cell of the predetermined number of the power conversion cells includes a short circuit configured to short-circuit an output unit of the power conversion cell,
wherein a short circuit unit corresponding to a portion of the predetermined number of the power conversion cells is configured to be short-circuited such that outputs of remaining power conversion cells are superimposed to output the single-phase AC,
wherein, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise, and
wherein, when numbers of available power conversion cells for the plurality of single-phase AC output units are not all a same number, the controller is configured to selectively use:
a first control state in which each of the plurality of single-phase AC output units superimposes only outputs of a number of the power conversion cells corresponding to a minimum number of the numbers of available power conversion cells to output the single-phase AC, and
a second control state in which each of the plurality of single-phase AC output units superimposes outputs of all available power conversion cells to output the single-phase AC such that phase differences between line-to-line voltages of adjacent phases among the phases are all equivalent.

2. The power converter according to claim 1, wherein the controller is configured to:
drive the power conversion cells by unipolar modulation based on the comparison between the voltage command value and the triangular waves, and
drive the power conversion cells by bipolar modulation based on the comparison between the voltage command value and the triangular waves,
wherein, when the numbers of available power conversion cells for the plurality of single-phase AC output units are not the same number, the controller is configured to:
use the second control state in a case of driving the power conversion cells by the unipolar modulation, and
use the first control state in a case of driving the power conversion cells by the bipolar modulation.

3. The power converter according to claim 1, wherein, when the numbers of available power conversion cells for the plurality of single-phase AC output units are not the same number, the controller is configured to:
use the first control state upon occurrence of a condition in which the output voltages of the power conversion cells are each less than or equal to a threshold, and
use the second control state upon occurrence of a condition in which an output voltage of the power converter is greater than or equal to a second threshold.

4. The power converter according to claim 1, wherein, in the first control state, for a single-phase AC output unit in which the number of available power conversion cells is greater than the minimum number, among the plurality of single-phase AC output units, the controller is configured to control output voltages of the available power conversion cells exceeding the minimum number to zero, to cause only outputs of a number of the power conversion cells corresponding to the minimum number to be superimposed to output the single-phase AC.

5. The power converter according to claim 1, wherein, in the first control state,
for single-phase AC output units in which the number of available power conversion cells is greater than the minimum number, among the plurality of single-phase AC output units, the controller is configured to switch off power conversion cells that do not contribute to the output voltage of a target single-phase AC output unit, among the available power conversion cells.

6. A controller configured to control a power converter including:
a plurality of single-phase AC output units for respective phases, each of the plurality of single-phase AC output units being configured to output single-phase AC and including a predetermined number of power conversion cells,
wherein the predetermined number is two or more,
wherein each of the power conversion cells is configured to:
convert power supplied from an external power supply into single-phase AC of a predetermined voltage and frequency, and
output the single-phase AC,
wherein output units of the predetermined number of the power conversion cells are connected in series to enable outputs of the predetermined number of the power conversion cells to be superimposed to output the single-phase AC,
wherein each power conversion cell of the predetermined number of the power conversion cells includes a short circuit configured to short-circuit an output unit of the power conversion cell, and
wherein, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise, the controller comprising:
circuitry configured to,
for each of the plurality of single-phase AC output units, drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise, and
selectively use, when numbers of available power conversion cells for the plurality of single-phase AC output units are not all a same number,
a first control state in which each of the plurality of single-phase AC output units superimposes only outputs of a number of the power conversion cells corresponding to a minimum number of the numbers of available power conversion cells to output the single-phase AC, and
a second control state in which each of the plurality of single-phase AC output units superimposes outputs of all available power conversion cells to output the single-phase AC such that phase differences between line-to-line voltages of adjacent phases among the phases are all equivalent.

7. A control method for a power converter including:
a plurality of single-phase AC output units for respective phases, each of the plurality of single-phase AC output units being configured to output single-phase AC and including a predetermined number of power conversion cells,
wherein the predetermined number is two or more,
wherein each of the power conversion cells is configured to:
convert power supplied from an external power supply into single-phase AC of a predetermined voltage and frequency, and
output the single-phase AC,
wherein output units of the predetermined number of the power conversion cells are connected in series to enable outputs of the predetermined number of the power conversion cells to be superimposed to output the single-phase AC,
wherein each power conversion cell of the predetermined number of the power conversion cells includes a short circuit configured to short-circuit an output unit of the power conversion cell, and
wherein, for each of the plurality of single-phase AC output units, the controller is configured to drive each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise, the control method comprising:
for each of the plurality of single-phase AC output units,
driving each of all or a portion of the predetermined number of the power conversion cells based on a comparison between a voltage command value and triangular waves having a same frequency and a same phase with shifted voltage levels, and to superimpose outputs of all or the portion of the predetermined number of the power conversion cells to change stepwise; and
selectively using, when numbers of available power conversion cells for the plurality of single-phase AC output units are not all a same number,
a first control state in which each of the plurality of single-phase AC output units superimposes only outputs of a number of the power conversion cells corresponding to a minimum number of the numbers of available power conversion cells to output the single-phase AC, and
a second control state in which each of the plurality of single-phase AC output units superimposes outputs of all available power conversion cells to output the single-phase AC such that phase differences between line-to-line voltages of adjacent phases among the phases are all equivalent.
